(19) United States
(12) Patent Application Publication
(10) Pub. No.: US 2026/0339169 A1
(43) Pub. Date: Oct. 29, 2026

(54) CAMERA MODULE

(71) Applicant: Samsung Electro-Mechanics Co., Ltd., Suwon-si (KR)

(72) Inventors: Bo Sung SEO, Suwon-si (KR); Nam Ju LEE, Suwon-si (KR); Min Jeong KANG, Suwon-si (KR)

(73) Assignee: Samsung Electro-Mechanics Co., Ltd., Suwon-si (KR)

(21) Appl. No.: 19/640,875

(22) Filed: Apr. 7, 2026

(30) Foreign Application Priority Data
Apr. 29, 2025 (KR) 10-2025-0056661
Mar. 6, 2026 (KR) 10-2026-0040692

(51) Int. Cl. G03B 13/36; G02B 27/64; G03B 5/00

(52) U.S. Cl. CPC G03B 13/36; G02B 27/646; G03B 5/00; G03B 2205/0007; G03B 2205/0069

(57) ABSTRACT

A camera module includes a fixed body; a movable body disposed in the fixed body, and configured to move in an optical axis direction; a first support unit and a second support unit disposed between the fixed body and the movable body, and configured to support a movement of the movable body in the optical axis direction; a driving unit configured to generate a driving force to move the movable body in the optical axis direction; and a plurality of position sensors configured to detect a position of the movable body in the optical axis direction, wherein the driving unit and the position sensor are respectively disposed on both sides of a virtual straight line connecting the first support unit and the second support unit when viewed in the optical axis direction.

### CROSS-REFERENCE TO RELATED APPLICATIONS

This application claims the benefit under 35 USC §119(a) of Korean Patent Application No. 10-2025-0056661 filed on Apr. 29, 2025, and Korean Patent Application No. 10-2026-0040692 filed on Mar. 6, 2026, in the Korean Intellectual Property Office, the entire disclosures of which are incorporated herein by reference for all purposes.

### BACKGROUND

### 1. Field

The following description relates to a camera module.

### 2. Description of Related Art

A camera module may be implemented in portable electronic devices such as, but not limited to, smartphones, tablet personal computers (PCs), or a laptop computers.

Portable electronic devices are a product group that are sensitive to an overall size including a thickness thereof, and in particular, a smartphone is more sensitive thereto. Accordingly, it is desirous that the camera module that is implemented in portable electronic devices may also be miniaturized and have a slim form factor.

As the camera modules that are implemented in the portable electronic devices achieves higher performance, the structure of the camera module has become increasingly complex.

A technical difficulty exists in maintaining or improving performance of the camera module while implementing miniaturization and slimness of the camera module.

The above information is presented as background information only to assist with an understanding of the present disclosure. No determination has been made, and no assertion is made, as to whether any of the above might be applicable as prior art with regard to the disclosure.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In a general aspect, a camera module includes a fixed body; a movable body disposed in the fixed body, and configured to move in an optical axis direction; a first support unit and a second support unit disposed between the fixed body and the movable body, and configured to support a movement of the movable body in the optical axis direction; a driving unit configured to generate a driving force to move the movable body in the optical axis direction; and a plurality of position sensors configured to detect a position of the movable body in the optical axis direction, wherein the driving unit and the plurality of position sensors are respectively disposed on both sides of a virtual straight line connecting the first support unit and the second support unit, when viewed in the optical axis direction.

The driving unit may include a magnet disposed on the movable body or the fixed body, and a coil disposed on the fixed body or the movable body and facing the magnet, wherein the plurality of position sensors may be disposed on the fixed body or the movable body together with the coil, and wherein the plurality of position sensors may be disposed on two adjacent surfaces of the fixed body or the movable body.

The plurality of position sensors may be disposed outside the coil.

The driving unit may include a first driving unit disposed on a first side of the virtual straight line and comprising a first magnet and a first coil; and a second driving unit disposed on a second side of the virtual straight line and comprising a second magnet and a second coil, and wherein the first support unit may be disposed closer to both the first driving unit and the second driving unit than to the second support unit.

The first driving unit and the second driving unit may be respectively disposed on the two adjacent surfaces of the movable body and the fixed body, and a direction in which the first magnet and the first coil face each other may be perpendicular to a direction in which the second magnet and the second coil face each other.

The first driving unit and the second driving unit may be disposed on a same surface of the movable body and the fixed body, and a direction in which the first magnet and the first coil face each other may be parallel to a direction in which the second magnet and the second coil face each other.

The first support unit may be disposed between a portion of the camera module where the two adjacent surfaces of the movable body meet and a portion of the camera module where the two adjacent surfaces of the fixed body meet, and the virtual straight line connecting the first support unit and the second support unit may not pass through the first driving unit or the second driving unit.

The first support unit may be disposed between one surface of the movable body and one surface of the fixed body facing each other in a first axis direction or a second axis direction, and the virtual straight line connecting the first support unit and the second support unit may not pass through the first driving unit or the second driving unit.

The first support unit and the second support unit may be disposed between a portion of the camera module where the two adjacent surfaces of the movable body meet, and a portion of the camera module where the two adjacent surfaces of the fixed body meet, or between one surface of the movable body and one surface of the fixed body that face each other in a first axis direction or a second axis direction.

The virtual straight line connecting the first support unit and the second support unit may not pass through the first driving unit or the second driving unit.

The camera module may further include a yoke disposed on the fixed body or the movable body, and facing the first magnet or the second magnet.

When the movable body moves in the optical axis direction, sliding friction may occur in one of the first support unit and the second support unit, and rolling friction may occur in another of the first support unit and the second support unit.

The first support unit comprises two ball members that are disposed in the optical axis direction.

The second support unit may include one ball member.

The movable body may include a first carrier to which a lens barrel is coupled, the fixed body may include a housing; and a second carrier in which the first carrier is disposed, and the second carrier is disposed in the housing, and the first carrier may be configured to move together with the second carrier in a direction perpendicular to the optical axis direction, and is further configured to move relative to the second carrier in the optical axis direction.

A plurality of ball members may be disposed between the second carrier and the housing, and the plurality of ball members may be in contact with the second carrier and the housing in the optical axis direction.

The movable body may include a first carrier to which a lens barrel is coupled; and a second carrier in which the first carrier is disposed, wherein the first carrier may be configured to move together with the second carrier in the optical axis direction, and may be further configured to move relative to the second carrier in the direction perpendicular to the optical axis direction.

A plurality of ball members may be disposed between the first carrier and the second carrier, and the plurality of ball members may be in contact with the first carrier and the second carrier in the optical axis direction.

In a general aspect, a camera module includes a fixed body; a movable body disposed in the fixed body, and configured to move in an optical axis direction; a first support unit and a second support unit disposed between the fixed body and the movable body, and configured to support a movement of the movable body in the optical axis direction; a plurality of driving units each comprising a magnet disposed on the movable body and a coil disposed on the fixed body and facing the magnet; and a plurality of position sensors respectively disposed on the fixed body, and configured to detect a position of the movable body in the optical axis direction, wherein the plurality of position sensors are disposed outside the plurality of coils.

The plurality of position sensors may be disposed on a same surface on which the plurality of coils are disposed, or may be disposed on a surface that is different from the surface on which the plurality of coils are disposed.

The plurality of position sensors may include a first position sensor that faces the movable body in a first axis direction perpendicular to the optical axis direction; and a second position sensor that faces the movable body in a second axis direction perpendicular to both the optical axis direction and the first axis direction.

The plurality of driving units and the plurality of position sensors may be respectively disposed on both sides of a virtual straight line connecting the first support unit and the second support unit.

The virtual straight line connecting the first support unit and the second support unit may be perpendicular to an optical axis and may extend obliquely with respect to a first axis perpendicular to the optical axis and a second axis perpendicular to both the optical axis and the first axis.

The camera module may further include yokes disposed on the fixed body and facing the plurality of magnets.

The plurality of driving units may include a first driving unit disposed on a first side of the virtual straight line and comprising a first magnet and a first coil; and a second driving unit disposed on a second side of the virtual straight line and comprising a second magnet and a second coil, wherein the first support unit may be disposed closer to both the first driving unit and the second driving unit than to the second support unit.

When the movable body moves in the optical axis direction, sliding friction may occur in one of the first support unit and the second support unit and rolling friction may occur in another of the first support unit and the second support unit.

The movable body may include a first carrier to which a lens barrel is coupled, the fixed body may include a housing; and a second carrier in which the first carrier is disposed, and the second carrier is disposed in the housing, wherein the first carrier may be configured to move together with the second carrier in a direction perpendicular to the optical axis direction, and is further configured to move relative to the second carrier in the optical axis direction.

A plurality of ball members may be disposed between the second carrier and the housing, and the plurality of ball members may be in contact with the second carrier and the housing in the optical axis direction.

The movable body may include a first carrier to which a lens barrel is coupled; and a second carrier in which the first carrier is disposed, the first carrier may be configured to move together with the second carrier in the optical axis direction, and may be further configured to move relative to the second carrier in a direction perpendicular to the optical axis direction.

A plurality of ball members may be disposed between the first carrier and the second carrier, and the plurality of ball members may be in contact with the first carrier and the second carrier in the optical axis direction.

Other features and aspects will be apparent from the following detailed description, the drawings, and the claims.

### BRIEF DESCRIPTION OF DRAWINGS

FIG. 1 illustrates a perspective view of an example camera module, in accordance with one or more embodiments.

FIGS. 2, 3, and 4 are illustrate various examples of an autofocus unit (a driving unit and a support unit), in accordance with one or more embodiments.

FIGS. 5 and 6 respectively illustrate exploded perspective views of the example camera module including the autofocus unit illustrated in FIG. 2.

FIGS. 7 and 8 respectively illustrate exploded perspective views of the example camera module including the autofocus unit illustrated in FIG. 3.

FIGS. 9 and 10 illustrate exploded perspective views of the example camera module which has an autofocus operation and an optical image stabilization operation, in accordance with one or more embodiments.

Throughout the drawings and the detailed description, unless otherwise described, the same reference numerals refer to the same elements. The drawings may not be to scale, and the relative size, proportions, and depiction of elements in the drawings may be exaggerated for clarity, illustration, and convenience.

### DETAILED DESCRIPTION

The following detailed description is provided to assist the reader in gaining a comprehensive understanding of the methods, apparatuses, and/or systems described herein. However, various changes, modifications, and equivalents of the methods, apparatuses, and/or systems described herein will be apparent after an understanding of the disclosure of this application. For example, the sequences within and/or of operations described herein are merely examples, and are not limited to those set forth herein, but may be changed as will be apparent after an understanding of the disclosure of this application, except for sequences within and/or of operations necessarily occurring in a certain order. As another example, the sequences of and/or within operations may be performed in parallel, except for at least a portion of sequences of and/or within operations necessarily occurring in an order, e.g., a certain order. Also, descriptions of features that are known after an understanding of the disclosure of this application may be omitted for increased clarity and conciseness.

Although terms such as "first," "second," and "third", or A, B, (a), (b), and the like may be used herein to describe various members, components, regions, layers, or sections, these members, components, regions, layers, or sections are not to be limited by these terms. Each of these terminologies is not used to define an essence, order, or sequence of corresponding members, components, regions, layers, or sections, for example, but used merely to distinguish the corresponding members, components, regions, layers, or sections from other members, components, regions, layers, or sections. Thus, a first member, component, region, layer, or section referred to in the examples described herein may also be referred to as a second member, component, region, layer, or section without departing from the teachings of the examples.

Throughout the specification, when a component or element is described as “on,” "connected to," "coupled to," or "joined to" another component, element, or layer, it may be directly (e.g., in contact with the other component, element, or layer) “on,” "connected to," "coupled to," or "joined to" the other component element, or layer, or there may reasonably be one or more other components elements, or layers intervening therebetween. When a component or element is described as "directly on", "directly connected to," "directly coupled to," or "directly joined to" another component element, or layer, there can be no other components, elements, or layers intervening therebetween. Likewise, expressions, for example, "between" and "immediately between" and "adjacent to" and "immediately adjacent to" may also be construed as described in the foregoing.

The terminology used herein is for describing various examples only and is not to be used to limit the disclosure. The articles "a," "an," and "the" are intended to include the plural forms as well, unless the context clearly indicates otherwise. As non-limiting examples, terms "comprise" or "comprises," "include" or "includes," and "have" or "has" specify the presence of stated features, numbers, operations, members, elements, and/or combinations thereof, but do not preclude the presence or addition of one or more other features, numbers, operations, members, elements, and/or combinations thereof, or the alternate presence of an alternative stated features, numbers, operations, members, elements, and/or combinations thereof. Additionally, while one embodiment may set forth such terms "comprise" or "comprises," "include" or "includes," and "have" or "has" specify the presence of stated features, numbers, operations, members, elements, and/or combinations thereof, other embodiments may exist where one or more of the stated features, numbers, operations, members, elements, and/or combinations thereof are not present.

As used herein, the term "and/or" includes any one and any combination of any two or more of the associated listed items. The phrases "at least one of A, B, and C", "at least one of A, B, or C", and the like are intended to have disjunctive meanings, and these phrases "at least one of A, B, and C", "at least one of A, B, or C", and the like also include examples where there may be one or more of each of A, B, and/or C (e.g., any combination of one or more of each of A, B, and C), unless the corresponding description and embodiment necessitates such listings (e.g., "at least one of A, B, and C") to be interpreted to have a conjunctive meaning.

The features described herein may be embodied in different forms, and are not to be construed as being limited to the examples described herein. Rather, the examples described herein have been provided merely to illustrate some of the many possible ways of implementing the methods, apparatuses, and/or systems described herein that will be apparent after an understanding of the disclosure of this application. The use of the term “may” herein with respect to an example or embodiment (e.g., as to what an example or embodiment may include or implement) means that at least one example or embodiment exists where such a feature is included or implemented, while all examples are not limited thereto. The use of the terms “example” or “embodiment” herein have a same meaning (e.g., the phrasing “in one example” has a same meaning as “in one embodiment”, and “one or more examples” has a same meaning as “in one or more embodiments”).

One or more example may provide a camera module that ensures performance while achieving miniaturization and slimness.

One or more example may also provide a camera module which has a reduced thickness in an optical axis direction and stably performs an autofocus operation.

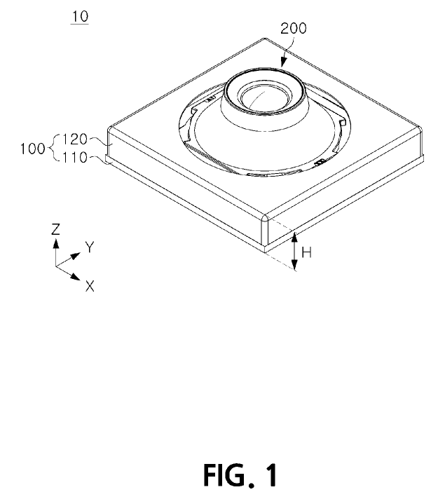

FIG. 1 illustrates a perspective view of an example camera module, in accordance with one or more embodiments.

A camera module 10, in accordance with one or more embodiments, may be implemented in portable electronic devices such as, but not limited to, smartphones, tablet personal computers (PCs), or laptop computers.

In an example embodiment, the camera module 10 may be implemented in a smartphone, and in this example, a thickness direction (Z-axis direction) of the camera module 10 may correspond to a thickness direction of the smartphone.

According to an example embodiment, the camera module 10 may have a significantly reduced thickness in the thickness direction (Z-axis direction).

A thickness H of the camera module 10 may be determined by a height of a fixed body 100 forming an exterior of the camera module 10.

Referring to FIG. 1, the fixed body 100 may include a housing 110 and a shield can 120 coupled to the housing 110, and the thickness H of the camera module 10 may be a distance from a lower surface of the housing 110 to an upper surface of the shield can 120 in a state in which the shield can 120 is coupled to the housing 110.

The camera module 10, in accordance with one or more embodiments, may have at least one operation of an autofocus operation (AF operation) and an optical image stabilization operation (OIS operation).

In example embodiments, the camera module 10 may have only the autofocus operation or may have both the autofocus operation and the optical image stabilization operation.

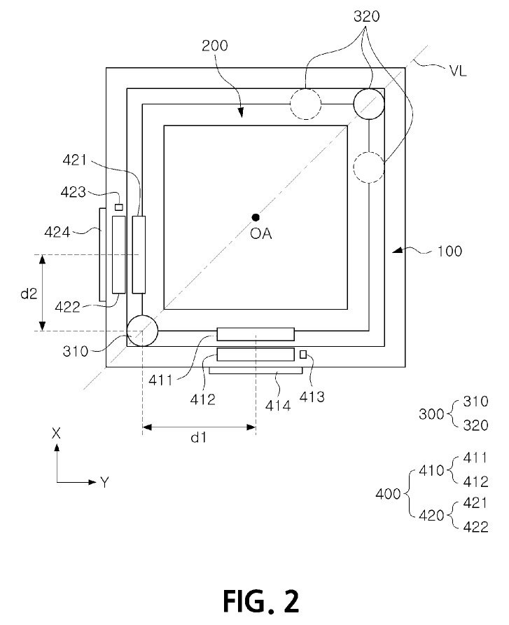

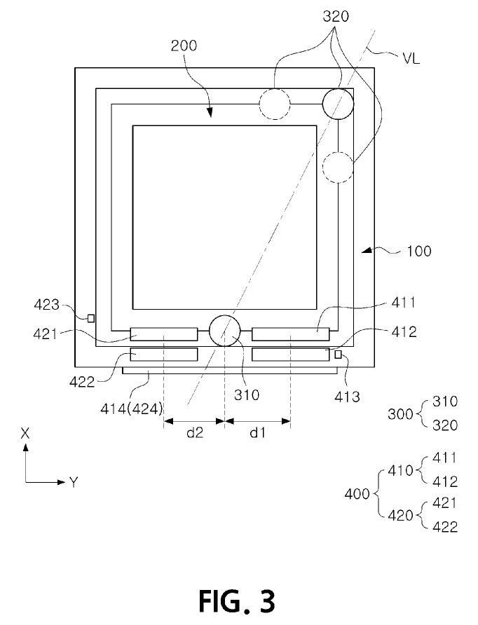

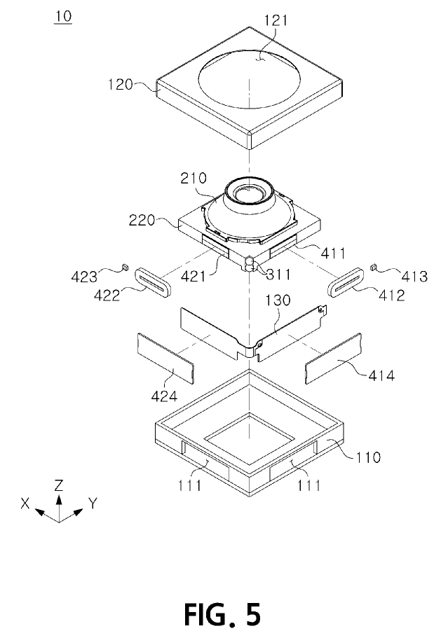

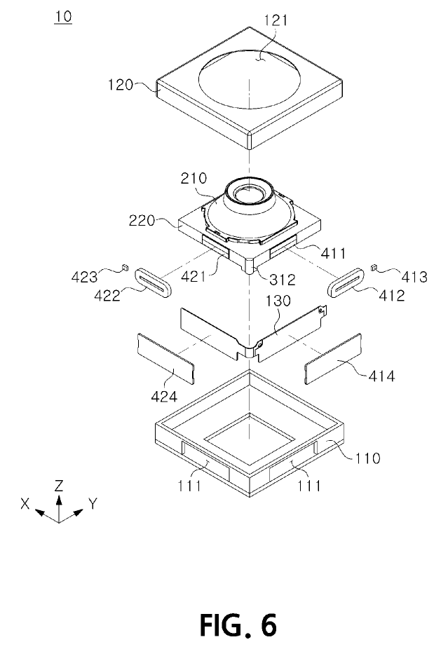

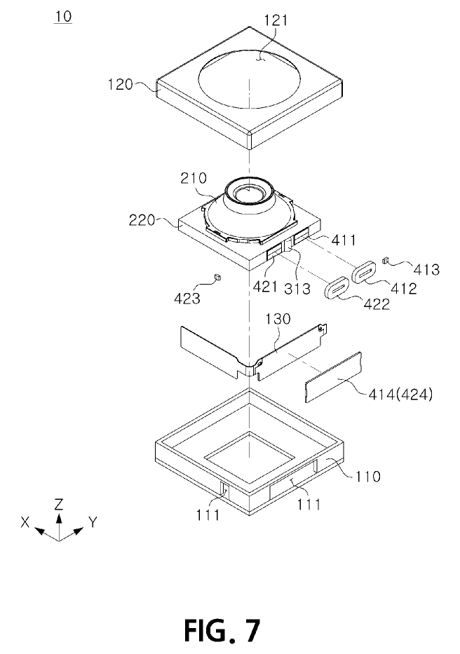

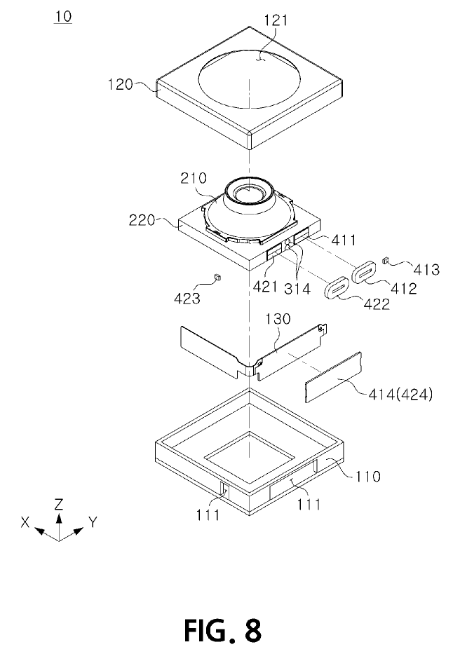

FIGS. 2 - 4 are diagrams illustrating arrangement forms of an autofocus unit (a driving unit and a support unit) , in accordance with one or more embodiments; FIGS. 5 and 6 are example exploded perspective views of the example camera module including the autofocus unit illustrated in FIG. 2, respectively; and FIGS. 7 and 8 are example exploded perspective views of the example camera module including the autofocus unit illustrated in FIG. 3, respectively.

The camera module 10, in accordance with one or more embodiments, may include the autofocus unit.

The autofocus unit may include an autofocus driving unit (hereinafter, a driving unit) which generates a driving force to move a movable body 200 in an optical axis direction (Z-axis direction), and a support unit which supports a movement of the movable body 200 in the optical axis direction (Z-axis direction). Furthermore, in addition to the driving unit and the support unit, all components necessary for implementing the autofocus operation may correspond to the autofocus unit.

The movable body 200 may be accommodated or disposed in an internal space in the fixed body 100, and may move relative to the fixed body 100 in the optical axis direction (Z-axis direction) during an autofocusing operation.

In the following description, unless separately defined with respect to the fixed body 100, the fixed body 100 may be understood as a concept including all components that do not move together with the movable body 200 in the optical axis direction (Z-axis direction) during autofocusing. For example, when the camera module 10 only performs the autofocus operation, the housing 110 and the shield can 120 may correspond to the fixed body 100; whereas when the camera module 10 further performs the optical image stabilization operation, a component may correspond to the fixed body 100 if the component does not move in the optical axis direction (Z-axis direction) even when the component moves in a direction (X-axis direction or Y-axis direction) perpendicular to the optical axis (Z-axis) during optical image stabilization.

Referring to FIGS. 2-4, the support unit 300 may be disposed between the movable body 200 and the fixed body 100, and the driving unit 400 may be disposed on each of the movable body 200 and the fixed body 100.

In example embodiments, the support unit 300 may include a first support unit 310 and a second support unit 320 that are spaced apart from each other. The driving unit 400 may include magnets 411 and 421 and coils 412 and 422 that are disposed to face each other.

Additionally, the autofocus unit may include position sensors 413 and 423, each of which detects a position of the movable body 200 in the optical axis direction (Z-axis direction).

In an example, the position sensors 413 and 423 may be Hall sensors. The position sensors 413 and 423 may be disposed adjacent to the driving unit 400, and may detect the position of the movable body 200 in the optical axis direction (Z-axis direction) by detecting a change in a magnetic field that is generated in the driving unit 400.

In example embodiments, the autofocus unit may include a plurality of driving units 410 and 420 and a plurality of position sensors 413 and 423.

The plurality of driving units 410 and 420 and the plurality of position sensors 413 and 423 may respectively be disposed on both sides of a virtual straight line VL that connects the first support unit 310 and the second support unit 320, which are spaced apart from each other when viewed in the optical axis direction (Z-axis direction).

The virtual straight line VL may be defined based on a straight line connecting the center of the first support unit 310 to the center of the second support unit 320, and may include an example in which the straight line passes through a point close to the center within a manufacturing tolerance range.

According to example embodiments, the camera module 10 may secure driving force during autofocusing by including the plurality of driving units 410 and 420, and may detect tilting of the movable body 200 with respect to the optical axis (Z-axis) by including the plurality of position sensors 413 and 423.

In example embodiments, one of the plurality of magnets 411 and 421 and the plurality of coils 412 and 422 may be disposed on the movable body 200, and the other of the plurality of magnets 411 and 421 and the plurality of coils 412 and 422 may be disposed on the fixed body 100.

Referring to FIGS. 2-4, the plurality of magnets 411 and 421 may be disposed on the movable body 200 and the plurality of coils 412 and 422 may be disposed on the fixed body 100. Additionally, the first position sensor 413 and the second position sensor 423 may be disposed on the fixed body 100 together with the first coil 412 and the second coil 422.

However, conversely, the plurality of magnets 411 and 421 may be disposed on the fixed body 100 and the plurality of coils 412 and 422 may be disposed on the movable body 200, and in this example, the plurality of position sensors 413 and 423 may be disposed on the movable body 200 together with the plurality of coils 412 and 422.

In example embodiments, the plurality of position sensors 413 and 423 may be disposed outside the plurality of coils 412 and 422.

In an example, the plurality of coils 412 and 422 may each be wound in a donut shape in which a hollow portion is formed within each of the plurality of coils 412 and 422, and the plurality of position sensors 413 and 423 may each be respectively disposed outside of the hollow region of the plurality of coils 412 and 422 and winding region of the plurality of coils 412 and 422.

According to example embodiments, the plurality of position sensors 413 and 423 may be disposed outside the plurality of coils 412 and 422, thereby contributing to slimness of the camera module 10.

Additionally, in example embodiments, the plurality of position sensors 413 and 423 may respectively be disposed on two adjacent surfaces of the fixed body 100 (or the movable body 200).

In an example, the fixed body 100 (or the movable body 200) may have a quadrangular shape including four side surfaces when viewed in the optical axis direction (Z-axis direction), and the plurality of position sensors 413 and 423 may respectively be disposed on two side surfaces that are perpendicular to each other among four side surfaces of the fixed body 100 (or the movable body 200).

According to example embodiments, the plurality of position sensors 413 and 423 may respectively be disposed on two adjacent surfaces of the fixed body 100 (or the movable body 200), thereby being configured to detect tilting of the movable body 200 with respect to the optical axis (Z-axis).

Hereinafter, various example embodiments of the autofocus unit, in accordance with one or more embodiments, are described in detail.

The plurality of driving units 410 and 420 may include the first driving unit 410 and the second driving unit 420. The first driving unit 410 may include the first magnet 411 and the first coil 412, and the second driving unit 420 may include the second magnet 421 and the second coil 422. The plurality of position sensors 413 and 423 may include the first position sensor 413, which is disposed adjacent to the first driving unit 410, and the second position sensor 423 which is disposed adjacent to the second driving unit 420.

In an example, the first driving unit 410 (the first magnet 411 and the first coil 412) and the first position sensor 413 may be disposed on one side of the virtual straight line VL which connects the first support unit 310 to the second support unit 320 when viewed in the optical axis direction (Z-axis direction), and the second driving unit 420 (the second magnet 421 and the second coil 422) and the second position sensor 423 may be disposed on the other side of the virtual straight line VL when viewed in the optical axis direction (Z-axis direction).

In example embodiments, the first support unit 310 and the second support unit 320 may be respectively disposed between a corner region of the movable body 200 and a corner region of the fixed body 100, or between one surface of the movable body 200 and one surface of the fixed body 100 facing each other in a direction perpendicular to the optical axis direction (Z-axis direction).

The corner region may indicate a portion where two adjacent surfaces meet and a region around, or adjacent to, the portion. For example, the corner region of the movable body 200 may indicate a portion where two adjacent surfaces of the movable body 200 meet and a region around the portion, and the corner region of the fixed body 100 may indicate a portion where two adjacent surfaces of the fixed body 100 meet and a region around the portion.

The corner region of the movable body 200 and the corner region of the fixed body 100 may face each other in a diagonal direction. The diagonal direction may indicate an oblique direction with respect to a first axis direction (X-axis direction) perpendicular to the optical axis direction (Z-axis direction) and a second axis direction (Y-axis direction) perpendicular to the optical axis direction (Z-axis direction) and the first axis direction (X-axis direction).

The movable body 200 and the fixed body 100 may each have a quadrangular shape including four side surfaces when viewed in the optical axis direction (Z-axis direction), and the side surfaces of the movable body 200 and the side surfaces of the fixed body 100 may face each other in the first axis direction (X-axis direction) or the second axis direction (Y-axis direction).

That is, in example embodiments, the first support unit 310 and the second support unit 320 may be disposed between the corner regions of the movable body 200 and the fixed body 100 facing each other in the diagonal direction, or may be disposed between one surface of the movable body 200 and one surface of the fixed body 100 facing each other in the first axis direction (X-axis direction) or the second axis direction (Y-axis direction).

In this example, the first support unit 310 and the second support unit 320 may be disposed to allow the virtual straight line VL connecting the first support unit 310 to the second support unit 320 to be perpendicular to the optical axis (Z-axis) and to obliquely extend with respect to a first axis (X-axis) perpendicular to the optical axis (Z-axis) and a second axis (Y-axis) perpendicular to the optical axis (Z-axis) and the first axis (X-axis).

In the example embodiments, the first support unit 310 may operate as a main guide, the second support unit 320 may operate as an auxiliary guide, and the first support unit 310 may be disposed closer to the first driving unit 410 and the second driving unit 420 than to the second support unit 320. Stated in another manner, the second support unit 320 may be disposed further from the first driving unit 410 and the second driving unit 420 than the first support unit 310.

For example, the sum of a distance between the first support unit 310 and the first driving unit 410 and a distance between the first support unit 310 and the second driving unit 420 may be less than the sum of a distance between the second support unit 320 and the first driving unit 410 and a distance between the second support unit 320 and the second driving unit 420.

In example embodiments, the first driving unit 410 and the second driving unit 420 may respectively be disposed on two adjacent surfaces of the movable body 200 and the fixed body 100, or may be disposed on the same surface of the movable body 200 or the fixed body 100.

In an example, the first driving unit 410 and the second driving unit 420 may respectively be disposed on two surfaces of the movable body 200 and the fixed body 100 that are perpendicular to each other. Accordingly, a direction in which the first magnet 411 and the first coil 412 face each other may be perpendicular to a direction in which the second magnet 421 and the second coil 422 face each other. In an example, the first magnet 411 and the first coil 412 may face each other in the first axis direction (X-axis direction), and the second magnet 421 and the second coil 422 may face each other in the second axis direction (Y-axis direction).

In another example, when the first driving unit 410 and the second driving unit 420 are disposed on the same surface of the movable body 200 and the fixed body 100, the direction in which the first magnet 411 and the first coil 412 face each other and the direction in which the second magnet 421 and the second coil 422 face each other may be parallel to each other. For example, the first magnet 411 and the first coil 412 and the second magnet 421 and the second coil 422 may all face each other in the first axis direction (X-axis direction) or the second axis direction (Y-axis direction).

In an example, the first support unit 310 and the second support unit 320 may be disposed to prevent the virtual straight line VL connecting the first support unit 310 to the second support unit 320 from passing through the first driving unit 410 and the second driving unit 420.

In other words, in example embodiments, the first support unit 310 and the second support unit 320 may be freely disposed between the movable body 200 and the fixed body 100 if the above-described conditions, such as an extension direction of the virtual straight line VL connecting the first support unit 310 to the second support unit 320, are satisfied.

For example, when a position of the first support unit 310 illustrated in FIGS. 2-4 is fixed, a position of the second support unit 320 may be changed to positions that are denoted by dotted lines illustrated in FIGS. 2-4 while satisfying the above-described conditions.

In example embodiments, the movable body 200 may move in the optical axis direction (Z-axis direction) based on a driving force that is generated by the first driving unit 410 and the second driving unit 420, and the first support unit 310 and the second support unit 320 may support a movement of the movable body 200 in the optical axis direction (Z-axis direction).

In example embodiments, when the movable body 200 moves in the optical axis direction (Z-axis direction), sliding friction may occur at one of the first support unit 310 and the second support unit 320, and rolling friction may occur at another one.

In an example embodiment, when the movable body 200 moves in the optical axis direction (Z-axis direction), rolling friction may occur at the first support unit 310 which operates as the main guide, and sliding friction may occur at the second support unit 320 which operates as the auxiliary guide.

Referring to FIG. 5, the first support unit 310 may include two ball members 311 disposed in the optical axis direction (Z-axis direction), and the second support unit 320 may include a support protrusion (not shown) disposed on the movable body 200 or the fixed body 100. In an example, the support protrusion may have a hemispherical shape and may be in point contact with a counterpart member.

In another example embodiment, sliding friction may occur at the first support unit 310 that operates as the main guide, and rolling friction may occur at the second support unit 320 that operates as the auxiliary guide.

Referring to FIG. 6, the first support unit 310 may include a shaft 312 disposed on the movable body 200 or the fixed body 100, and the second support unit 320 may include one ball member (not shown). For example, the shaft 312 may have a cylindrical shape or a semi-cylindrical shape extending in the optical axis direction (Z-axis direction) and may be in line contact with a counterpart member.

Sliding friction may generate a greater frictional force than rolling friction, and driving stability of the movable body 200 may thus be improved when a sliding friction structure is applied to the first support unit 310 that operates as the main guide.

Additionally, according to example embodiments, the plurality of driving units 410 and 420 may be disposed closer to the first support unit 310 operating as the main guide, thereby offsetting a frictional force that is increased due to a sliding structure.

According to the example embodiments illustrated in FIGS. 5 and 6, the first support unit 310 and the second support unit 320 may be spaced apart from each other with respect to the optical axis (Z-axis) in a substantially diagonal direction. In an example, the first support unit 310 may be disposed between the corner region of the movable body 200 and the corner region of the fixed body 100, and the second support unit 320 may be disposed on an opposite side of the corner region in which the first support unit 310 is disposed with respect to the optical axis (Z-axis).

Referring to FIGS. 6, 7, and 8, the first support unit 310 may be disposed between one surface of the movable body 200 and one surface of the fixed body 100 that faces the one surface of the movable body 200.

In an example, the first support unit 310 may be implemented as the shaft 312 having a cylindrical shape or a semi-cylindrical shape and extending in the optical axis direction (Z-axis direction) as illustrated in FIG. 6, or as a plurality of support protrusions 314 having hemispherical shapes and arranged in the optical axis direction (Z-axis direction) as illustrated in FIG. 8, and the second support unit 320 may include one ball member (not shown).

In an example, the first support unit 310 may be implemented as a shaft 313 having a cylindrical shape or a semi-cylindrical shape, and extending in the optical axis direction (Z-axis direction) as illustrated in FIG. 7. The shaft 313 may be disposed between the first magnet 411 and the second magnet 421 on a surface of the movable body 200 that is between the movable body 200 and the fixed body 100.

In the one or more examples, the first support unit 310 and the second support unit 320 are described as having structures that generate different types of frictional force. However, in an example, both the first support unit 310 and the second support unit 320 may be ball members that generate rolling friction, or injection-molded products that generate sliding friction.

In the example embodiments, the autofocus unit may include a plurality of yokes 414 and 424 disposed to face the plurality of magnets 411 and 421.

In an example, when the plurality of magnets 411 and 421 are disposed on the movable body 200, the plurality of yokes 414 and 424 may be disposed on the fixed body 100.

The plurality of yokes 414 and 424 may include the first yoke 414 facing the first magnet 411 and the second yoke 424 facing the second magnet 421. However, when the first magnet 411 and the second magnet 421 are disposed on the same surface of the movable body 200 as illustrated in FIG. 3, the first yoke 414 and the second yoke 424 do not need to be separately provided, and one yoke may thus be provided.

The plurality of yokes 414 and 424 may each be formed of a material including a magnetic material and may generate magnetic attraction forces between the plurality of yokes 414 and 424 and the plurality of magnets 411 and 421.

The magnetic attraction forces between the plurality of yokes 414 and 424 and the plurality of magnets 411 and 421 may act in directions in which the yokes and the magnets face each other.

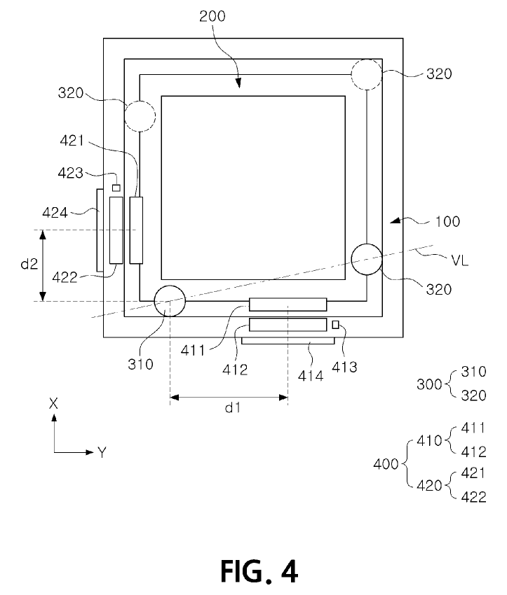

In the example embodiments illustrated in FIGS. 2 and 4, an attraction force may act between the first yoke 414 and the first magnet 411 in the first axis direction (X-axis direction), and an attraction force may act between the second yoke 424 and the second magnet 421 in the second axis direction (Y-axis direction). In the example embodiment illustrated in FIG. 3, an attraction force may act between the first yoke 414 and the first magnet 411 and between the second yoke 424 and the second magnet 421 in the first axis direction (X-axis direction) or the second axis direction (Y-axis direction).

In the following description, an attraction force acting between the first yoke 414 and the first magnet 411 is referred to as a first attraction force, and an attraction force acting between the second yoke 424 and the second magnet 421 is referred to as a second attraction force.

Referring to FIG. 2, in an example embodiment, a magnitude of the first attraction force and a magnitude of the second attraction force may be substantially identical to each other, and a distance d1 from the first support unit 310 to a point of action of the first attraction force and a distance d2 from the first support unit 310 to a point of action of the second attraction force may be different from each other.

Accordingly, an unbalanced rotation moment may act on the first support unit 310, and the movable body 200 may rotate about the first support unit 310 in a specific direction.

Referring to FIGS. 2 and 4, when the magnitude of the first attraction force and the magnitude of the second attraction force are identical to each other and the distance d1 from the first support unit 310 to the point of action of the first attraction force is greater than the distance d2 from the first support unit 310 to the point of action of the second attraction force, the movable body 200 may rotate clockwise about the first support unit 310.

The second support unit 320 may be disposed in a position for restricting rotation of the movable body 200 and may support the movable body 200 to prevent rotation of the movable body 200.

In another example embodiment, the distance d1 from the first support unit 310 to the point of action of the first attraction force, and the distance d2 from the first support unit 310 to the point of action of the second attraction force may be set to be substantially identical to each other, and magnitudes of the first attraction force and the second attraction force may be set to be different from each other.

The magnitude of the first attraction force and the magnitude of the second attraction force may be adjusted by making sizes of the first magnet 411 and the second magnet 421 different from each other or by making sectional areas of the first yoke 414 and the second yoke 424 different from each other.

Referring to FIG. 3, a size of the first magnet 411 and a size of the first yoke 414 may be greater than a size of the second magnet 421 and a size of the second yoke 424, and accordingly, the movable body 200 may rotate clockwise about the first support unit 310. The second support unit 320 may be disposed in a position for restricting rotation of the movable body 200.

As described above, the autofocus unit may include the first position sensor 413 and the second position sensor 423 which detect the position of the movable body 200 in the optical axis direction (Z-axis direction).

In example embodiments, the first position sensor 413 and the second position sensor 423 may respectively be disposed on two adjacent surfaces of the fixed body 100.

In an example, the first position sensor 413 may be disposed on the fixed body 100 to face the movable body 200 in the first axis direction (X-axis direction), and the second position sensor 423 may be disposed on the fixed body 100 to face the movable body 200 in the second axis direction (Y-axis direction).

That is, in an example, the first position sensor 413 and the second position sensor 423 may be disposed on the same surface as the first coil 412 and the second coil 422 on the fixed body 100. However, one of the first position sensor 413 and the second position sensor 423 may be disposed on a surface that is different from a surface on which the first coil 412 or the second coil 422 is disposed.

As illustrated in FIG. 3 and the like, in the example embodiments in which the first driving unit 410 and the second driving unit 420 are disposed on the same surface of the movable body 200 and the fixed body 100, respectively, the first position sensor 413 may be disposed on a surface different from a surface on which the first coil 412 is disposed, or the second position sensor 423 may be disposed on a surface different from a surface on which the second coil 422 is disposed.

While the movable body 200 is not tilted relative to the optical axis (Z-axis), the position of the movable body 200 in the optical axis direction (Z-axis direction) that is detected by the first position sensor 413, and the position of the movable body 200 in the optical axis direction (Z-axis direction) that is detected by the second position sensor 423 may be substantially identical to each other.

On the other hand, while the movable body 200 is tilted relative to the optical axis (Z-axis), the position of the movable body 200 in the optical axis direction (Z-axis direction) detected by the first position sensor 413 and the position of the movable body 200 in the optical axis direction (Z-axis direction) detected by the second position sensor 423 may be different from each other.

For example, an intensity of a magnetic field detected by the first position sensor 413 may be greater or less than an intensity of a magnetic field detected by the second position sensor 423.

According to example embodiments closure, tilting of the movable body 200 may be detected based on intensities of the magnetic fields detected by the first position sensor 413 and the second position sensor 423, and a posture of the movable body 200 may be controlled based on the same intensities.

Next, components included in the camera module 10 are described with further reference to FIGS. 5-8.

The camera module 10 may include the fixed body 100 and the movable body 200.

The fixed body 100 may include the housing 110 having an internal space and the shield can 120 coupled to the housing 110.

The movable body 200 may be a portion that is accommodated in the fixed body 100, and moves relative to the fixed body 100 in the optical axis direction (Z-axis direction).

The movable body 200 may include an optical member. In an example, the optical member may be a plurality of lenses or an image sensor.

According to an example embodiment, the movable body 200 may include a plurality of lenses as the optical member.

The movable body 200 may include a lens barrel 210 on which the plurality of lenses are mounted and a first carrier 220 to which the lens barrel 210 is coupled.

The lens barrel 210 and the first carrier 220 may be accommodated in the internal space of the housing 110, and may move relative to the housing 110 in the optical axis direction (Z-axis direction).

The first support unit 310 and the second support unit 320 may be disposed between the first carrier 220 and the housing 110.

The first support unit 310 and the second support unit 320 may be in contact with the first carrier 220 and the housing 110, respectively.

In the example embodiments illustrated in FIGS. 5-8, the second support unit 320 may be disposed in the corner region (not shown) in the drawings. However, as described above, a position of the second support unit 320 is not limited to a specific position.

The first magnet 411 and the second magnet 421 may be disposed on the first carrier 220, and the first coil 412 and the second coil 422 may be disposed on the housing 110.

The first coil 412 and the second coil 422 may be mounted on a substrate 130, and the substrate 130 on which the first coil 412 and the second coil 422 are mounted may be disposed on the housing 110.

In the example embodiments, the substrate 130 may be disposed across two adjacent surfaces of the housing 110. That is, the substrate 130 may include two surfaces.

The housing 110 may include one or more through-holes 111 in the surface on which the substrate 130 is mounted.

The first coil 412 and the second coil 422 may be respectively disposed on a surface of the substrate 130 facing the first carrier 220, and may directly face the first magnet 411 and the second magnet 421 through the through-hole 111.

Each of the first magnet 411 and the second magnet 421 may include a north pole (N-pole) and a south pole (S-pole) disposed on one surface facing the first coil 412 and the second coil 422.

For example, the N-pole (or the S-pole), a neutral region, and the S-pole (or the N-pole) may be disposed on one surface of each of the first magnet 411 and the second magnet 421 along the optical axis direction (Z-axis direction).

When power is applied to the first coil 412 and the second coil 422, the movable body 200 may move in the optical axis direction (Z-axis direction) based on an electromagnetic force that is generated by the first magnet 411 and the first coil 412, and based on an electromagnetic force that is generated by the second magnet 421 and the second coil 422.

The plurality of position sensors 413 and 423 and the plurality of yokes 414 and 424 may be respectively disposed on the substrate 130 together with the plurality of coils 412 and 422.

The plurality of position sensors 413 and 423 may respectively be disposed on two surfaces of the substrate 130. For example, the first position sensor 413 may be disposed on one of the two surfaces of the substrate 130, and the second position sensor 423 may be disposed on the other of the two surfaces of the substrate 130.

Additionally, the first position sensor 413 and the second position sensor 423 may be disposed on a surface of the substrate 130 facing the first carrier 220, and may directly face the first magnet 411 and the second magnet 421 through the through-hole 111 or may directly face the first carrier 220.

The plurality of yokes 414 and 424 may be respectively disposed to face the plurality of magnets 411 and 421 with the plurality of coils 412 and 422 disposed therebetween. That is, the plurality of yokes 414 and 424 may be respectively disposed on a surface of the substrate 130 opposite to the surface of the substrate 130 facing the first carrier 220.

The fixed body 100 may include a stopper (not shown) that may prevent a separation of the support unit 300, and may limit a movement distance of the movable body 200 in the optical axis direction (Z-axis direction).

The stopper may be disposed on the housing 110 and/or the shield can 120 included in the fixed body 100.

In example embodiments in which the first support unit 310 and/or the second support unit 320 are implemented as ball members, the housing 110 and/or the shield can 120 may include the stopper at a position corresponding to each of the first support unit 310 and the second support unit 320.

The stopper may protrude from a lower surface of the housing 110 and/or an upper surface of the shield can 120 toward the first support unit 310 and the second support unit 320 in the optical axis direction (Z-axis direction).

A gap between the stopper and the first support unit 310 and/or the second support unit 320 in the optical axis direction (Z-axis direction) may be less than a gap between the housing 110 and/or the shield can 120 and the first carrier 220 in the optical axis direction (Z-axis direction).

Accordingly, separation of the ball members included in the first support unit 310 and/or the second support unit 320 may be prevented.

Additionally, the first support unit 310 may collide first with the stopper of the shield can 120 before the first carrier 220 collides with the shield can 120, thereby limiting a movement distance of the first carrier 220, and further preventing a direct collision between the first carrier 220 and the shield can 120.

In example embodiments in which the first support unit 310 and/or the second support unit 320 may be implemented as injection molded products, the housing 110 and/or the shield can 120 may include a stopper that protrudes toward the first carrier 220 in the optical axis direction (Z-axis direction).

The stopper may be formed of the same material as the housing 110 and/or the shield can 120 on which the stopper is disposed or may be formed of an elastic material that is configured to absorb an impact. In the latter example, the stopper may further provide effects such as impact mitigation and noise reduction.

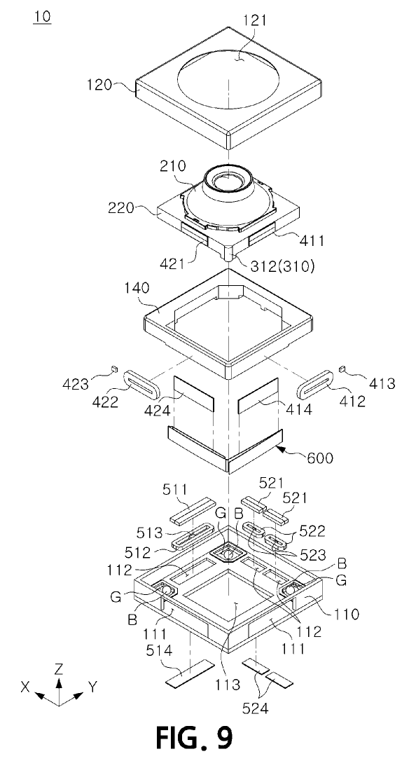

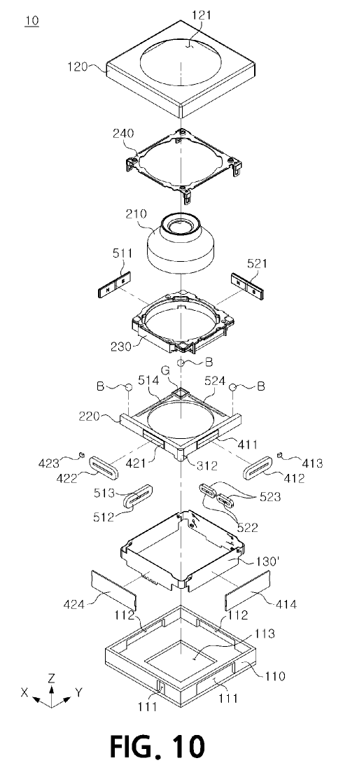

FIGS. 9 and 10 are example exploded perspective views of the example camera module having the autofocus operation and the image stabilization operation, in accordance with one or more embodiments.

The camera module 10, in accordance with one or more embodiments, may include the autofocus unit and an image stabilization unit.

A description of the autofocus unit is replaced by the above description, and hereinafter, the image stabilization unit of the camera module 10 is mainly described with reference to FIGS. 9 and 10.

Referring to FIG. 9, the camera module 10 may have the image stabilization unit accommodating the autofocus unit.

Referring to FIG. 9, the camera module 10 may include the housing 110 which has an internal space, the shield can 120 which is coupled to the housing 110, the lens barrel 210 on which a plurality of lenses are mounted, and the first carrier 220 to which the lens barrel 210 is coupled, and may further include a second carrier 140 which is disposed between the housing 110 and the first carrier 220.

The first carrier 220 may be accommodated in the second carrier 140, and may move in the optical axis direction (Z-axis direction).

The second carrier 140 may not move in the optical axis direction (Z-axis direction), and accordingly, the second carrier 140 may be included in the fixed body 100 according to the above-described definition of the fixed body 100.

The second carrier 140 may be accommodated in the housing 110 and may move in the direction perpendicular to the optical axis direction (Z-axis direction), that is, the first axis direction (X-axis direction) or the second axis direction (Y-axis direction).

The first carrier 220 may be accommodated in the second carrier 140, and accordingly, the first carrier 220 may move together with the second carrier 140 in the first axis direction (X-axis direction) or the second axis direction (Y-axis direction).

According to the example embodiment illustrated in FIG. 9, the plurality of coils 412 and 422, the plurality of position sensors 413 and 423, and the plurality of yokes 414 and 424 may be disposed on the second carrier 140.

In an example embodiment, the plurality of coils 412 and 422, the plurality of position sensors 413 and 423, and the plurality of yokes 414 and 424 may be mounted on a substrate 600, and, in an example, the substrate 600 on which these components are mounted may be disposed on the second carrier 140.

Although the second carrier 140 may be included in the fixed body 100 that may not move in the optical axis direction (Z-axis direction), the second carrier 140 may move in the first axis direction (X-axis direction) or the second axis direction (Y-axis direction) perpendicular to the optical axis direction (Z-axis direction).

Accordingly, the substrate 600 on which the plurality of coils 412 and 422 or the like are mounted may support movement of the second carrier 140.

In the example embodiment illustrated in FIG. 9, at least a portion of the substrate 600 on which the plurality of coils 412 and 422 or the like are mounted may be formed of a flexible material, and the substrate 600 may be a connection substrate 600 that connects the fixed body 100 to the movable body 200.

The connection substrate 600 may have a shape that is bent a plurality of times. One end of the connection substrate 600 may be disposed on the second carrier 140, the other end of the connection substrate 600 may be disposed on the housing 110, and the remaining portion of the connection substrate 600 may extend between the second carrier 140 and the housing 110.

The connection substrate 600 may be spaced apart from the second carrier 140 and the housing 110 in the first axis direction (X-axis direction) and the second axis direction (Y-axis direction).

A portion of the connection substrate 600 may be fixed to the housing 110 that may not move in the first axis direction (X-axis direction) or the second axis direction (Y-axis direction), thereby elastically supporting movement of the second carrier 140.

A plurality of ball members B may be disposed between the second carrier 140 and the housing 110. In a non-limited example, the plurality of ball members B may include three ball members.

The second carrier 140 may be three-point supported on the housing 110 through the plurality of ball members B, and may maintain a predetermined gap from the housing 110.

The plurality of ball members B may support a movement of the second carrier 140 in the first axis direction (X-axis direction) or the second axis direction (Y-axis direction).

The plurality of ball members B may respectively be disposed in three corner regions of the housing 110. For example, when the first support unit 310 is disposed in a first corner region, the plurality of ball members B may be disposed in the remaining three corner regions in which the first support unit 310 is not disposed.

The second carrier 140 and the housing 110 may include a plurality of guide grooves G in surfaces of the second carrier 140 and the housing 110 facing each other in the optical axis direction (Z-axis direction).

The second carrier 140 and the housing 110 may each include guide grooves G whose number corresponds to the number of the plurality of ball members B, and the plurality of ball members B may be individually disposed in the plurality of guide grooves G.

The plurality of guide grooves G that are formed or disposed in the second carrier 140, and the plurality of guide grooves G that are formed or disposed in the housing 110 may face each other in the optical axis direction (Z-axis direction), and the plurality of ball members B may be disposed therebetween.

The plurality of ball members B may be in contact with, and supported by, the plurality of guide grooves G that are formed or disposed in the second carrier 140 and the plurality of guide grooves G that are formed or disposed in the housing 110 in the optical axis direction (Z-axis direction).

Additionally, each of the plurality of guide grooves G may have a width that is greater than a diameter of each of the plurality of ball members B.

That is, the plurality of ball members B may be in one-point contact with the second carrier 140 and the housing 110 in the optical axis direction (Z-axis direction) and may freely roll in the first axis direction (X-axis direction) or the second axis direction (Y-axis direction) within a space defined by the plurality of guide grooves G.

In an example embodiment, the image stabilization unit may include an image stabilization driving unit (hereinafter, a third driving unit) that generates a driving force to move the second carrier 140 in the first axis direction (X-axis direction) or the second axis direction (Y-axis direction).

The third driving unit 500 may include a first sub driving unit 510 that generates a driving force in the first axis direction (X-axis direction) and a second sub driving unit 520 that generates a driving force in the second axis direction (Y-axis direction).

The first sub driving unit 510 may include a first sub magnet 511 and a first sub coil 512 disposed to face each other, and the second sub driving unit 520 may include a second sub magnet 521 and a second sub coil 522 disposed to face each other.

The first sub driving unit 510 and the second sub driving unit 520 may be disposed on the second carrier 140 and the housing 110, respectively, and may be disposed perpendicular to each other.

In an example embodiment, the first sub magnet 511 and the second sub magnet 521 may be disposed perpendicular to each other on one surface of the second carrier 140 facing the housing 110 in the optical axis direction (Z-axis direction), and the first sub coil 512 and the second sub coil 522 may be disposed perpendicular to each other on one surface of the housing 110 facing the second carrier 140 in the optical axis direction (Z-axis direction).

Conversely, the first sub magnet 511 and the second sub magnet 521 may be disposed on the housing 110, and the first sub coil 512 and the second sub coil 522 may be disposed on the second carrier 140.

In an example embodiment, the first sub coil 512 or the second sub coil 522 may include a plurality of coils.

For example, the first sub coil 512 may include one coil that faces the first sub magnet 511, and the second sub coil 522 may include two coils that face the second sub magnet 521.

The two coils included in the second sub coil 522 may be independently controlled.

The first sub coil 512 and the second sub coil 522 may be mounted on a substrate (not shown), and the substrate on which the first sub coil 512 and the second sub coil 522 are mounted may be disposed on the housing 110.

The housing 110 may include a through-hole 112 in one or more surfaces on which the substrate is mounted.

The first sub coil 512 and the second sub coil 522 may directly face the first sub magnet 511 and the second sub magnet 521 through the through-hole 112.

Each of the first sub magnet 511 and the second sub magnet 521 may include an N-pole and an S-pole disposed on one surface facing the first sub coil 512 and the second sub coil 522.

The N-pole (or the S-pole), a neutral region, and the S-pole (or the N-pole) may be disposed on one surface of the first sub magnet 511 along the first axis direction (X-axis direction).

When power is applied to the first sub coil 512, the second carrier 140 may move in the first axis direction (X-axis direction) by electromagnetic force generated by the first sub magnet 511 and the first sub coil 512.

An N-pole (or an S-pole), a neutral region and an S-pole (or an N-pole) may be disposed on one surface of the second sub magnet 521 along the second axis direction (Y-axis direction).

When power is applied to the second sub coil 522, the second carrier 140 may move in the second axis direction (Y-axis direction) based on an electromagnetic force that is generated by the second sub magnet 521 and the second sub coil 522.

A plurality of position sensors 513 and 523 may be disposed on the substrate.

The plurality of position sensors 513 and 523 may be Hall sensors, and may detect a position of the second carrier 140 by detecting changes in magnetic fields that are generated in the first sub driving unit 510 and the second sub driving unit 520.

The plurality of position sensors 513 and 523 may be disposed in inner sides (hollow regions) of the plurality of sub coils 512 and 522, respectively.

The plurality of position sensors 513 and 523 may also directly face the first sub magnet 511 and the second sub magnet 521 through the through-hole 112.

The plurality of position sensors 513 and 523 may include a third position sensor 513 that faces the first sub magnet 511 and a fourth position sensor 523 that faces the second sub magnet 521, respectively.

In an example embodiment, the plurality of position sensors 513 and 523 may include three or more position sensors that detect rotation of the second carrier 140.

In an example, one third position sensor 513 may be provided, and two fourth position sensors 523 may be provided.

A plurality of yokes 514 and 524 may be disposed on the housing 110.

The plurality of yokes 514 and 524 may include the third yoke 514 that faces the first sub magnet 511 and the fourth yoke 524 that faces the second sub magnet 521.

The plurality of yokes 514 and 524 may each be formed of a material including a magnetic material, and may generate a magnetic attraction force with each of the plurality of sub magnets 511 and 521.

A magnetic attraction force between the plurality of yokes 514 and 524 and the plurality of sub magnets 511 and 521 may act in directions in which these components face each other.

The plurality of yokes 514 and 524 may face the plurality of sub magnets 511 and 521 in the optical axis direction (Z-axis direction) with the plurality of sub coils 512 and 522 disposed therebetween, and accordingly, a magnetic attraction force therebetween may act in the optical axis direction (Z-axis direction).

Due to a magnetic attraction force between the plurality of yokes 514 and 524 and the plurality of sub magnets 511 and 521, the plurality of ball members B may maintain a contact state with the second carrier 140 and the housing 110.

Referring to FIG. 10, the camera module 10 may have the autofocus unit that accommodates the image stabilization unit.

Referring to FIG. 10, the camera module 10 may have the autofocus unit that accommodates the image stabilization unit.

Referring to FIG. 10, the camera module 10 may include the housing 110 which has an internal space, the shield can 120 coupled to the housing 110, the lens barrel 210 on which a plurality of lenses are mounted, a first carrier 230 to which the lens barrel is coupled, and a second carrier 220 disposed between the housing 110 and the first carrier 230.

In the example embodiment illustrated in FIG. 10, each of the first carrier 230 and the second carrier 220 may be moved in the optical axis direction (Z-axis direction), and accordingly, the first carrier 230 and the second carrier 220 may be included in the movable body 200.

The first carrier 230 may be accommodated in the second carrier 220, and may move relative to the second carrier 220 in the direction perpendicular to the optical axis direction (Z-axis direction), that is, the X-axis direction or the Y-axis direction. Accordingly, the plurality of ball members B may be disposed between the first carrier 230 and the second carrier 220.

In an example, the plurality of ball members B may be in one-point contact with the first carrier 230 and the second carrier 220 in the optical axis direction (Z-axis direction).

The plurality of sub magnets 511 and 521 may be disposed on the first carrier 230, and the plurality of yokes 514 and 524 may be disposed on the second carrier 220, and may face the plurality of sub magnets 511 and 521 in the optical axis direction (Z-axis direction).

Due to a magnetic attraction force acting between the plurality of sub magnets 511 and 521 and the plurality of yokes 514 and 524, the plurality of ball members B may maintain contact with the first carrier 230 and the second carrier 220.

In an example embodiment, the first magnet 411 and the second magnet 421 may be disposed on two surfaces of the second carrier 220 perpendicular to each other, and the first sub magnet 511 and the second sub magnet 521 may be disposed on two surfaces of the first carrier 230 perpendicular to each other.

Referring to FIG. 10, the first sub magnet 511 may be disposed parallel to the first magnet 411, and the second sub magnet 521 may be disposed parallel to the second magnet 421.

In an example, the first coil 412, the second coil 422, the first sub coil 512, and the second sub coil 522 may be disposed on four side surfaces of the housing 110, respectively.

The first coil 412, the second coil 422, the first sub coil 512, and the second sub coil 522 may be mounted on a substrate 130', and the substrate 130' on which these components are mounted may be disposed on the housing 110.

The substrate 130' may surround four side surfaces of the housing 110, and the first coil 412, the second coil 422, the first sub coil 512, and the second sub coil 522 may each be mounted on different side surfaces of the substrate 130'.

Position sensors 413, 423, 513, and 523 may also be mounted on the substrate 130' together with the coils 412, 422, 512, and 522.

Finally, the camera module 10, in accordance with one or more embodiments, may include an image sensor (not shown) that converts incident light into an electrical signal.

In accordance with one or more embodiments, the image sensor may be mounted on a sensor substrate, and may be disposed on a lower surface of the housing 110. The image sensor may face the lens barrel 210 on which a plurality of lenses are mounted in the optical axis direction (Z-axis direction) through a through-hole 113 that is formed in the lower surface of the housing 110. Accordingly, light passing through the plurality of lenses may be incident on the image sensor.

An infrared cut filter (IR cut filter) that blocks light in an infrared region among incident light may be further disposed between the image sensor and the lens barrel 210.

In accordance with one or more embodiments, the image sensor may be disposed on the movable body 200. The image sensor may be disposed on the movable body 200, and may move in one or more of the optical axis direction (Z-axis direction), the first axis direction (X-axis direction), and the second axis direction (Y-axis direction).

As set forth above, the example embodiments may provide a camera module that has a reduced thickness in the optical axis direction, and stably performs the autofocus operation.

While this disclosure includes specific examples, it will be apparent after an understanding of the disclosure of this application that various changes in form and details may be made in these examples without departing from the spirit and scope of the claims and their equivalents. The examples described herein are to be considered in a descriptive sense only, and not for purposes of limitation. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner, and/or replaced or supplemented by other components or their equivalents.

Therefore, in addition to the above and all drawing disclosures, the scope of the disclosure is also inclusive of the claims and their equivalents, i.e., all variations within the scope of the claims and their equivalents are to be construed as being included in the disclosure.

What is claimed is:

1. A camera module, comprising:
a fixed body;
a movable body disposed in the fixed body, and configured to move in an optical axis direction;
a first support unit and a second support unit disposed between the fixed body and the movable body, and configured to support a movement of the movable body in the optical axis direction;
a driving unit configured to generate a driving force to move the movable body in the optical axis direction; and
a plurality of position sensors configured to detect a position of the movable body in the optical axis direction,
wherein the driving unit and the plurality of position sensors are respectively disposed on both sides of a virtual straight line connecting the first support unit and the second support unit, when viewed in the optical axis direction.

2. The camera module according to claim 1, wherein the driving unit comprises:
a magnet disposed on the movable body or the fixed body, and
a coil disposed on the fixed body or the movable body and facing the magnet,
wherein the plurality of position sensors are disposed on the fixed body or the movable body together with the coil, and
wherein the plurality of position sensors are disposed on two adjacent surfaces of the fixed body or the movable body.

3. The camera module according to claim 2, wherein the plurality of position sensors are disposed outside the coil.

4. The camera module according to claim 2, wherein the driving unit comprises:
a first driving unit disposed on a first side of the virtual straight line and comprising a first magnet and a first coil; and
a second driving unit disposed on a second side of the virtual straight line and comprising a second magnet and a second coil, and
wherein the first support unit is disposed closer to both the first driving unit and the second driving unit than to the second support unit.

5. The camera module according to claim 4, wherein the first driving unit and the second driving unit are respectively disposed on the two adjacent surfaces of the movable body and the fixed body, and
wherein a direction in which the first magnet and the first coil face each other is perpendicular to a direction in which the second magnet and the second coil face each other.

6. The camera module according to claim 4, wherein the first driving unit and the second driving unit are disposed on a same surface of the movable body and the fixed body, and
wherein a direction in which the first magnet and the first coil face each other is parallel to a direction in which the second magnet and the second coil face each other.

7. The camera module according to claim 4, wherein the first support unit is disposed between a portion of the camera module where the two adjacent surfaces of the movable body meet and a portion of the camera module where the two adjacent surfaces of the fixed body meet, and
wherein the virtual straight line connecting the first support unit and the second support unit does not pass through the first driving unit or the second driving unit.

8. The camera module according to claim 4, wherein the first support unit is disposed between one surface of the movable body and one surface of the fixed body facing each other in a first axis direction or a second axis direction, and
wherein the virtual straight line connecting the first support unit and the second support unit does not pass through the first driving unit or the second driving unit.

9. The camera module according to claim 4, wherein the first support unit and the second support unit are disposed between a portion of the camera module where the two adjacent surfaces of the movable body meet, and a portion of the camera module where the two adjacent surfaces of the fixed body meet, or between one surface of the movable body and one surface of the fixed body that face each other in a first axis direction or a second axis direction.

10. The camera module according to claim 9, wherein the virtual straight line connecting the first support unit and the second support unit does not pass through the first driving unit or the second driving unit.

11. The camera module according to claim 4, further comprising a yoke disposed on the fixed body or the movable body, and facing the first magnet or the second magnet.

12. The camera module according to claim 4, wherein, when the movable body moves in the optical axis direction, sliding friction occurs in one of the first support unit and the second support unit, and rolling friction occurs in another of the first support unit and the second support unit.

13. The camera module according to claim 12, wherein the first support unit comprises two ball members that are disposed in the optical axis direction.

14. The camera module according to claim 12, wherein the second support unit comprises one ball member.

15. The camera module according to claim 1, wherein the movable body comprises a first carrier to which a lens barrel is coupled,
the fixed body comprises:
a housing; and
a second carrier in which the first carrier is disposed, and the second carrier is disposed in the housing, and
the first carrier is configured to move together with the second carrier in a direction perpendicular to the optical axis direction, and is further configured to move relative to the second carrier in the optical axis direction.

16. The camera module according to claim 15, wherein a plurality of ball members are disposed between the second carrier and the housing, and
wherein the plurality of ball members are in contact with the second carrier and the housing in the optical axis direction.

17. The camera module according to claim 1, wherein the movable body comprises:
a first carrier to which a lens barrel is coupled; and
a second carrier in which the first carrier is disposed,
wherein the first carrier is configured to move together with the second carrier in the optical axis direction, and is further configured to move relative to the second carrier in a direction perpendicular to the optical axis direction.

18. The camera module according to claim 17, wherein a plurality of ball members are disposed between the first carrier and the second carrier, and
wherein the plurality of ball members are in contact with the first carrier and the second carrier in the optical axis direction.

19. A camera module, comprising:
a fixed body;
a movable body disposed in the fixed body, and configured to move in an optical axis direction;
a first support unit and a second support unit disposed between the fixed body and the movable body, and configured to support a movement of the movable body in the optical axis direction;
a plurality of driving units each comprising a magnet disposed on the movable body and a coil disposed on the fixed body and facing the magnet; and
a plurality of position sensors respectively disposed on the fixed body, and configured to detect a position of the movable body in the optical axis direction,
wherein the plurality of position sensors are disposed outside the plurality of coils.

20. The camera module according to claim 19, wherein the plurality of position sensors are disposed on a same surface on which the plurality of coils are disposed, or are disposed on a surface that is different from the surface on which the plurality of coils are disposed.

21. The camera module according to claim 20, wherein the plurality of position sensors comprise:
a first position sensor that faces the movable body in a first axis direction perpendicular to the optical axis direction; and
a second position sensor that faces the movable body in a second axis direction perpendicular to both the optical axis direction and the first axis direction.

22. The camera module according to claim 19, wherein the plurality of driving units and the plurality of position sensors are respectively disposed on both sides of a virtual straight line connecting the first support unit and the second support unit.

23. The camera module according to claim 22, wherein the virtual straight line connecting the first support unit and the second support unit is perpendicular to an optical axis and extends obliquely with respect to a first axis perpendicular to the optical axis and a second axis perpendicular to both the optical axis and the first axis.

24. The camera module according to claim 22, further comprising yokes disposed on the fixed body and facing the plurality of magnets.

25. The camera module according to claim 22, wherein the plurality of driving units comprise:
a first driving unit disposed on a first side of the virtual straight line and comprising a first magnet and a first coil; and
a second driving unit disposed on a second side of the virtual straight line and comprising a second magnet and a second coil,
wherein the first support unit is disposed closer to both the first driving unit and the second driving unit than to the second support unit.

26. The camera module according to claim 19,
wherein, when the movable body moves in the optical axis direction, sliding friction occurs in one of the first support unit and the second support unit and rolling friction occurs in another of the first support unit and the second support unit.

27. The camera module according to claim 19, wherein the movable body comprises a first carrier to which a lens barrel is coupled,
the fixed body comprises:
a housing; and
a second carrier in which
the first carrier is disposed, and the second carrier is disposed in the housing,
wherein the first carrier is configured to move together with the second carrier in a direction perpendicular to the optical axis direction, and is further configured to move relative to the second carrier in the optical axis direction.

28. The camera module according to claim 27, wherein a plurality of ball members are disposed between the second carrier and the housing, and
wherein the plurality of ball members are in contact with the second carrier and the housing in the optical axis direction.

29. The camera module according to claim 19, wherein the movable body comprises:
a first carrier to which a lens barrel is coupled; and
a second carrier in which the first carrier is disposed,
wherein the first carrier is configured to move together with the second carrier in the optical axis direction, and is further configured to move relative to the second carrier in a direction perpendicular to the optical axis direction.

30. The camera module according to claim 29, wherein a plurality of ball members are disposed between the first carrier and the second carrier, and
wherein the plurality of ball members are in contact with the first carrier and the second carrier in the optical axis direction.
